(19) United States
(12) Patent Application Publication
(10) Pub. No.: US 2012/0127820 A1
(43) Pub. Date: May 24, 2012

(54) Polymer Blending System

(76) Inventor: Jerry W. Noles, JR., Newcastle, OK (US)

(21) Appl. No.: 12/952,373

(22) Filed: Nov. 23, 2010

(51) Int. Cl. B01F 15/04

(52) U.S. Cl. 366/142

(57) ABSTRACT

A system for blending polymers and other chemicals in an aqueous liquid is provided. Static mixers and tubes, preferably in one or more tube bundles, provide a volume sufficient to allow a residence time in the system to hydrate a polymer. Static mixers may be integrated with a tube bundle. The system may be mounted on a portable base such as a trailer. The concentration of polymer and chemicals in water may be controlled by a controller.

### BACKGROUND OF INVENTION

1. Field of the Invention

This invention is directed to method and apparatus for placing water-soluble polymers and other chemicals into water to produce optimum properties of the solution and to obtain data to facilitate the process. More particularly, a portable tube bundle containing static mixers for effective blending without excessive shearing or damage to the polymer and chemical transport and storage apparatus with sensors and a programmable chemical delivery system are provided.

2. Description of Related Art

One purpose of a blending or mixing system as disclosed herein is to allow a water-soluble polymer and other chemicals to be blended from a dispersion in oil into water or an aqueous liquid and to obtain maximum benefits of the polymer. Such a device is commonly called a blending system when used in conjunction with the fluids used in oil and gas wells. It may be used in any application where there is a need to mix polymer in a continuous and a controlled manner. To insure the effective and even distribution of the polymer into the water, the polymer must be wet by the water and thoroughly dispersed such that the polymer does not form clusters or aggregates, often called “fisheyes.” The polymer normally requires sufficient agitation and retention time as to allow the polymer chains to unfold, causing the polymer solution to reach its maximum dispersion. With batch mixing, this retention time is accomplished by the use of tanks that have a large enough capacity to allow the mixture proper retention time prior to use. Normally, this is performed through the use of two or more compartmented tanks that allow mixing to occur in one or more tanks while the fluid that has already been mixed in the other tank or tanks is pumped. The size of the tanks used for this type of batch mixing is dependent on the rate that the fluid is being pumped from the system and the total mixing time required for the chemicals being used, but the tanks are expensive to transport and they form a large footprint. One of the major limitations to batch mixing is that conditions may change and a batch may not be needed for pumping into a well. This creates the problem of disposing of the mixed solution.

The amount of fluid used in many oil and gas well completion operations has increased in size. In horizontal wells, higher pump rates generally must be used to perform flow or circulation within the wellbore during completion operations, such as drilling out plugs and removing solids. The polymers that are introduced into the fluid medium help not only to transport the particles but also to reduce the frictional pressure loss as fluid is pumped at higher rates through tubulars in the well bore. It is important that the polymers and any other chemicals added to the fluid be introduced in a controlled operation. Preferably, the composition and properties of the fluid mixed and pumped should be measured and the data preserved.

Injection rates used in hydraulic fracturing operations have also increased in recent years. Polymer is added to the fluids to decrease friction pressure drop as the fracturing fluid (called “slick water”) is injected. Other types of polymers may be used to help suspend proppant in the fluid. In many cases the polymers being used do not have sufficient contact and mixing time prior to being pumped into the wellbore to completely hydrate, thereby limiting the effectiveness of the polymers.

In some cases larger tanks with recirculation pumps have been incorporated into the completion and fracturing operations in an effort to improve the mixing and retention time of polymers. However, the recirculation pumps may lead to excessive shear of polymers, which can break the long chains of the polymers that are being mixed, resulting in lower effectiveness of the polymer solution.

U.S. Pat. No. 7,048,432 discloses a method and apparatus for hydrating a polymer for use in wells. The polymer solution is directed through a housing containing rotating impellers. U.S. Pat. No. 4,828,034 discloses mixing a polymer into an oil-based fluid to form an oil-based polymer concentrate, then injecting the oil-based slurry into a water stream and pumping the mixture through a high-shear pump and a static mixer into a first holding tank, then pumping the liquid through a second high-shear pump into a second holding tank. U.S. Pat. No. 4,336,345 discloses formation of a polymer concentrate containing an inhibitor to hydration, then reversing the inhibitor reaction to allow full hydration of the polymer.

What is needed is a blending system that overcomes the lack of retention time, excess shearing of the solution, the complexity of batch and continuous operations disclosed above and that can maintain a steady pump and mixing rate at an economical cost.

### BRIEF SUMMARY OF THE INVENTION

The method and apparatus disclosed herein eliminate the need for batch mixing and multiple retention tanks for polymer mixing. In-line static mixers agitate and mix polymer in water as it is being pumped through the system. The static mixers generate gentle agitation, allowing the polymer to be thoroughly mixed in the aqueous solution without damaging the polymer by excessive shearing. The invention also provides improved retention or contact time between the aqueous solution and the polymer by providing stable flow of the solution through tubes. The tubes may be in a tube bundle. The system may operate with a programmed control system for chemical injection, thereby reducing the number of personnel required to perform the mixing operation, may be portable for transport to well sites, and may record data indicating composition and properties of the fluids blended.

### BRIEF DESCRIPTION OF THE SEVERAL VIEWS OF THE DRAWING(S)

FIG. 1 is a sketch of apparatus for continuous in-line hydration of polymer and apparatus for sensing and recording data.

FIG. 2 is a drawing of a tube bundle in a case as disclosed herein.

FIG. 3 is an isometric view of tubes and static mixers in a tube bundle.

FIG. 4 is an isometric view of a portable blending system as disclosed herein.

### DETAILED DESCRIPTION OF THE INVENTION

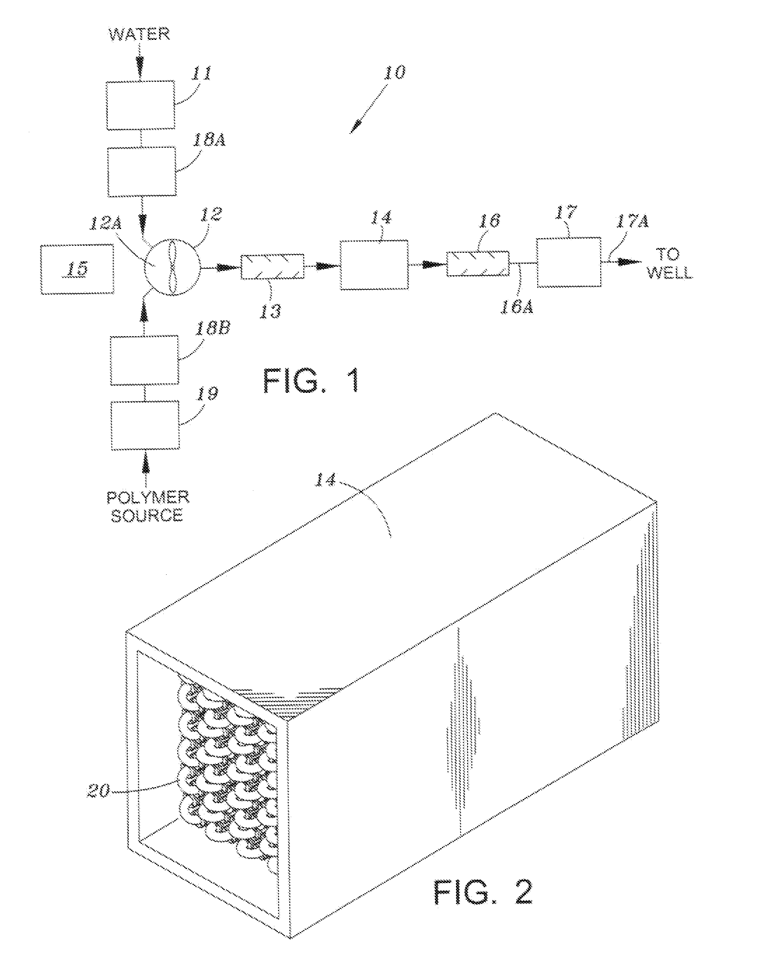

Referring to FIG. 1, blending system 10 may intake water or an aqueous liquid into pump 11, which pumps the liquid through water flow meter 18A to connection 12, where a second liquid stream is added to the water. Connection 12 may contain sensors 12A, which may be used to measure temperature, salinity, surfactant or other chemical composition and any other variable that is relevant to the properties or effectiveness of the blended liquid. Sensors 12A are connected to controller 15. Pump 11 is necessary only if water pressure is not sufficient. The liquid may then go to static mixer 13 (as shown) or directly to tube bundle 14. Static mixers 13 and 16 may be arranged to receive liquid before or after tube bundle 14 Line 16A carries the blended liquid to pump 17. Polymer or other chemical is added to the water stream at connection 12 in the form of a concentrated suspension or solution in the second liquid, normally oil. Flow meter 18A measures the rate of water flow and flow meter 18B measures The rate of oil flow. Both flow meters send a signal to controller 15. Metering valve 19 controls rate of flow of the oil stream according to a pre-programmed signal from controller 15 to supply a desired concentration of chemical in the stream exiting connection 12. Such controllers and valves are well known in industry. Solenoid valves such as manufactured by Sun Hydraulics, for example, may be used as valve 19 to control fluid flow rate based on electrical control signals that shift a spool or cartridge. Controller 15 may be manually changed during use or respond to signals from a sensor.

System 10 requires very little energy to operate and may use pressure of the water source. Alternatively, pump 11 may be necessary. In-line mixing allows a higher range of flow rates to be used without reducing the effectiveness of the polymer being mixed by applying excessive shear rate to the solution.

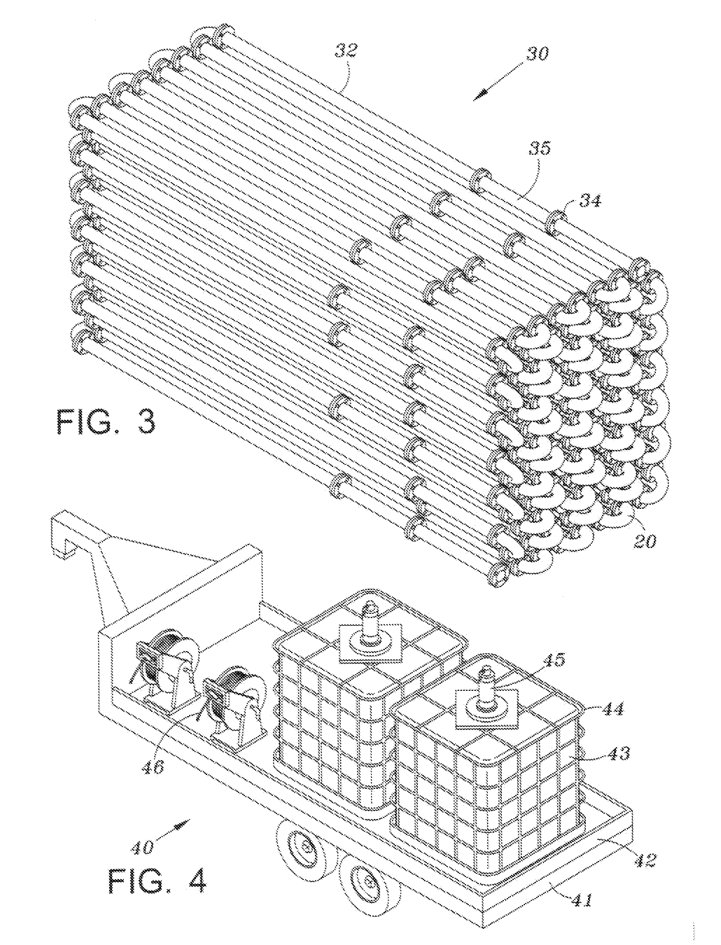

System 10 preferably uses a continuous length of pipe or tube that is tightly compacted to reduce the size of the overall package (a “tube bundle”), such as illustrated in FIG. 2 and FIG. 3. Tube bundle 30 (FIG. 3) includes straight tubes 32 that may be placed parallel and connected with curved ends 20. A selected number of straight tubes 32 may include a segment containing static mixer 35. Static mixer 35 may be joined in a straight tube by flange 34, by a weld or by any other method for joining tubes. The length and diameter of the tubes allows sufficient contact time to allow the aqueous solution to become properly hydrated. The tube bundle may incorporate inline static mixers positioned throughout the length of the assembly to gently agitate the solution during pumping and to insure complete and thorough mixing of the solution. A suitable static mixer is a “Kenics” mixer available from Chemineer, Inc. of North Andover, Mass. The entire tube bundle may be enclosed in box 14 (FIG. 2), which may have insulated walls.

The tube bundle may be positioned in vertical, horizontal or inclined position. The tubes and connectors may be made of ferrous or non-ferrous material, including plastics or rubber hosing or any combination. The tubes must have sufficient diameter and length to provide a proper retention time. The tubes may have a diameter from 2 inches to 6 inches and a total length from about 100 feet to whatever length is necessary to achieve the needed retention time. The volume of tubes should be sufficient to provide proper retention time of the liquid in system 10. A plurality of tube bundles may be used in the system. They may be connected in series or in parallel. The combination of directional change in tube bundles, combined with the inline static mixers, generates effective and thorough agitation and mixing of the polymer in the aqueous solution. The directional changes further reduce the amount of time required for mixing without damaging the polymer molecules. In one embodiment the volume of tubes and static mixers is selected to allow a retention time of 20 minutes at a pump rate of 100 gallons per minute. This contact time is defined as from the time the aqueous liquid and polymer is introduced into connection 12 until the time the solution leaves the system through outlet conduit 17A.

In a different embodiment using tube bundles, the system may be assembled as a mobile unit that is small and light-weight and that can be transported on a trailer. A trailer such as shown in FIG. 4 may be used to transport tube bundles or, as shown in the figure, may be used to transport portable polymer system 40, or both. Multiple tube bundles may be mounted on a trailer and connected in series or in parallel to provide greater capacity. The bed of the trailer may be storage tank 41, which serves as a spill-containment vessel. Vessel 41 is preferably sized to contain the volume of liquid to be transported in system 40. Barrier 42 forms a leak-free spill structure that encloses liquid tanks 43. It is a very important feature of the trailer that the trailer has built-in capacity in tank 41 to hold the contents of the tanks 43. Tanks 43 may hold a suspension of polymer in oil, such as available in industry from chemical suppliers, and other chemicals. Tanks 43 may be made from polymer and require rods 44 to prevent excessive deformation when the tanks are full of liquid. Liquid may be forced from tanks by pneumatic-operated piston pump 45. Hose and reel 46 can be used for air supply to operate pumps 45. The polymer concentrate may be pumped through a hose (not shown) to metering valve 19 (FIG. 1). Pumps 45 may incorporate an inline air regulator to control the pressure between the pneumatic pump and metering valve 19. This allows constant pressure to be supplied to the metering valve as the valve opens and closes due to changes in the flow rate of the incoming liquid and provides great flexibility for a wide range of pump rates without affecting the mix ratios. In one embodiment, positive pressure chemical injection pump 45 may have programmable logic from controller 15 that allows the injection of the chemicals to be maintained at a constant ratio based on the input or pump rate of the incoming aqueous liquid measured at flow meter 18 and also allows pump 45 to respond to selected variables such as temperature, pressure, salt composition in water, and any other measurable quantity that may be selected to control chemical injection rate. In another embodiment, the rate of chemical injection is programmed using valve 19 to control flow rate, which may respond to selected variables, such as temperature, pressure, salt composition in water, and any other measurable quantity that may be selected to control chemical injection rate. Tube bundles such as shown in FIG. 2 may, alternatively, be installed on the same trailer as tanks 43.

Referring to FIG. 1, downstream of the blending and data acquisition system is normally high-pressure pump 17, which may have pressure gauge 17A at the output of the pump. Data indicating pressure at this point is preferably sent to controller 15, where it may be recorded and later used to analyze the effects of blending operations on pressure at the wellhead as fluid is injected.

Although the present invention has been described with respect to specific details, it is not intended that such details should be regarded as limitations on the scope of the invention, except to the extent that they are included in the accompanying claims. Modifications to the invention may be made as might occur to one skilled in the field of the invention within the scope of the appended claims. All embodiments contemplated hereunder that achieve the objects of the invention have not been shown in complete detail. Other embodiments may be developed without departing from the spirit of the invention or from the scope of the appended claims.

I claim:

1. A system for blending polymers to form a polymer solution in water, comprising:
a water flow meter for connection to a source of water;
a connection for adding a suspension of polymer in oil to the water, the connection being flow connected to the flow meter for the source of water;
a tube bundle, flow connected to the connection and comprising a plurality of sections of tubes and static mixers;
a flow meter for the suspension of polymer in oil flow connected to a supply line and to the connection for adding a suspension of polymer in oil;
a device for controlling flow rate of the suspension of polymer in oil; and
a controller for sending signals to the device in response to a signal received by the controller.

2. The system of claim 1 wherein the device for controlling flow rate of the suspension is a valve.

3. The system, of claim 1 wherein the device for controlling flow rate of the suspension is a pump for the suspension of polymer in oil.

4. The system of claim 1 further comprising a static mixer outside the tube bundle and flow connected to the tube bundle.

5. The system of claim 1 further comprising a pump for water flow connected to the source of water.

6. The system of claim 1 wherein a volume of the tube bundle is selected to provide a selected residence time of fluid flowing through the tube bundle at a selected flow rate.

7. The system of claim 1 wherein the tube bundle is enclosed in a heat-insulated box.

8. The system of claim 1 further comprising a sensor for sending temperature or chemical composition signals to the controller.

9. The system of claim 1 further comprising a high-pressure pump having a discharge pressure gage wherein a pressure signal is sent to the controller from the pressure sensor on the output of the high-pressure pump.

10. The system of claim 1 further comprising a data storage device for storing data from a sensor in the system.

11. A portable system for blending a polymer solution in water, comprising:
the system of claim 1 further comprising a trailer, the trailer having a bed formed from a storage tank having a selected volume and a flow barrier around the bed, the system being disposed on the trailer.

12. A portable system for transporting and supplying a polymer dispersion in oil, comprising:
a trailer, the trailer having a bed formed from a storage tank having a selected volume and a flow barrier around the bed;
a vessel for containing the polymer dispersion disposed on the bed; and
a pump for pumping the polymer dispersion from the vessel.

13. The system of claim 10 wherein the pump is pneumatically-driven.

14. The system of claim 11 wherein the rate of pumping of the pump is controlled by a signal from a controller.
